(19) United States
(12) Patent Application Publication
(10) Pub. No.: US 2012/0062987 A1
(43) Pub. Date: Mar. 15, 2012

(54) ADAPTOR FOR MICROSCOPES

(75) Inventors: Brian J. HNATKOVICH, Coalport, PA (US); Christopher R. LITTEN, Bellefonte, PA (US); Craig STOUT, Port Matilda, PA (US)

(73) Assignee: QBC DIAGNOSTICS, INC., Port Matilda, PA (US)

(21) Appl. No.: 13/231,141

(22) Filed: Sep. 13, 2011

Related U.S. Application Data
(60) Provisional application No. 61/382,909, filed on Sep. 14, 2010.

(51) Int. Cl. G02B 21/06

(52) U.S. Cl. 359/385

(57) ABSTRACT

A fluorescent microscope attachment is disclosed that includes a removable filter arm to provide an adaptor for use in transforming a light microscope into a fluorescent microscope. The adaptor may further include an LED light source and/or a magnetic microscope objective attachment.

### FIELD

The present disclosure relates to an adaptor for an objective lens of a microscope and, more particularly, to an adaptor that converts an ordinary microscope into a fluorescent microscope.

### BACKGROUND

Fluorescent Microscopy (FM) is a microscopy technique that utilizes fluorescent chromophores to detect several target substrates. These substrates include many causes of infectious diseases, including the malaria parasites and Mycobacterium tuberculosis, the causative agent of tuberculosis.

Utilization of FM for the detection and diagnosis of such diseases has been shown to be much more sensitive and specific than corresponding microscopic methods utilizing conventional light microscopes. Reducing the incidence of such diseases by incorporating methods such as FM has become the goal of many world health organizations.

In the past, fluorescent microscopes have been unavailable to a large percentage of microscopists. In a large number of laboratories, the technology is not feasible due to high capital costs, expensive and dangerous light sources, training requirements, delicate instrumentation and lack of appropriate infrastructure. However, with the advancement of LED based fluorescent systems, which eliminates some of these problems, FM technology has started to become more prevalent.

There have been several devices that can be used to retrofit existing bright field microscopes and transform them into fluorescent microscopes. One such exemplary adaptor for microscopes is described in U.S. Pat. No. 5,198,927, the content of which is incorporated by reference herein. However, this and other prior adaptors can be cumbersome to attach and further lack the ability to readily change filter sets when the microscopic application changes.

These and other drawbacks are present in current fluorescent microscopes and adaptors.

### SUMMARY

Exemplary embodiments are directed to a fluorescent microscope attachment designed for easy attachment to a conventional microscope, easy changing of microscope objective lenses, and which allow for the easy changing and interchanging of filter sets depending on the application.

According to various aspects of the disclosure, an adaptor for converting a conventional, non-fluorescent light microscope into a fluorescent microscope is described.

The adaptor comprises a body member configured at one end thereof to attach to a body tube of the microscope and configured at an opposite end thereof to attach to a microscope objective lens, the body tube further having an opening formed in a side thereof and a filter arm assembly insertable into the opening of the body member such that the filter arm assembly is removably attached to the body member. The filter arm assembly has a light path therethrough that intersects an axial light path through the body member extending from the body tube to the objective lens, the filter arm assembly further comprising a filter cube for fluorescent microscopy disposed therein.

In one embodiment, the adaptor comprises a body member configured at one end thereof for detachably coupling directly to a body tube of the microscope and configured at another end thereof for magnetically coupling to a microscope objective lens, the body member having an axial light path running longitudinally therethrough, the body member including an opening in a radial direction relative to the longitudinal dimension of the body member; a filter arm assembly slidably insertable into the opening of the body member in a single orientation such that the filter arm assembly has a radial light path which intersects the axial light path, the filter arm assembly being magnetically attached to the body member; and a light source removably attached to an end of the filter arm assembly opposite the body member, the light source comprising an LED and disposed to emit light from the LED along the radial light path. The filter arm assembly further comprises a first filter disposed in the radial light path downstream of the light source for passing light at wavelengths which excite fluorescence in a specimen to be examined in the microscope and for blocking light at wavelengths where visible fluorescence emission occurs in the specimen, a reflector disposed at the intersection of the axial light path and radial light path, the reflector passing light through the axial light path and reflecting light at excitation wavelengths, and a second filter disposed in the axial light path and disposed between the reflector and the eye piece, the second filter blocking light at wavelengths shorter than the emission wavelength of a fluorophore used with a specimen being examined and which wavelengths pass through the reflector.

According to another aspect of the disclosure, an adaptor kit for converting a conventional, non-fluorescent light microscope into a fluorescent microscope comprises a first filter arm assembly removably insertable into a side opening of a body member configured to attach to a body tube of the microscope and configured at an opposite end thereof to attach to a microscope objective lens, the first filter arm assembly having a light path therethrough that intersects an axial light path through the body member extending from the body tube to the objective lens, the filter arm assembly further comprising a first filter cube for fluorescent microscopy disposed therein associated with a first predetermined wavelength; and a second filter arm assembly removably insertable into the side opening of the body member, the second filter arm assembly having a light path therethrough that intersects the axial light path through the body member, the second filter arm assembly further comprising a second filter cube for fluorescent microscopy disposed therein associated with a second predetermined wavelength.

According to another aspect of the disclosure, a method of adapting a conventional, non-fluorescent microscope into a fluorescent microscope includes providing an adaptor as described herein, attaching the body member of the adaptor to the objective lens, and attaching the body member to the body tube of the microscope.

In various aspects, a manual of operation and instruction for use for the apparatus consistent with article of manufacture may be provided.

Some further advantages and embodiments may become evident from the attached drawings.

### BRIEF DESCRIPTION OF THE DRAWINGS

FIG. 1 is a side elevational view of a microscope including an adaptor according to various aspects of the disclosure.

FIG. 2 depicts a perspective view of an adaptor in accordance with an exemplary embodiment.

FIG. 3 depicts an unassembled view of the adaptor shown in FIG. 2.

FIGS. 4a and 4b depict a perspective and exploded view, respectively, of a filter arm assembly in accordance with an exemplary embodiment.

FIGS. 5a and 5b depict a perspective and exploded view, respectively, of a body member in accordance with an exemplary embodiment.

FIGS. 6a and 6b depict a perspective and exploded view, respectively, of a light source in accordance with an exemplary embodiment.

Where like parts appear in more than one drawing, it has been attempted to use like reference numerals for clarity.

### DETAILED DESCRIPTION OF EXEMPLARY EMBODIMENTS

Exemplary embodiments are directed to an improved fluorescent microscope adaptor to turn a conventional light microscope into a fluorescent microscope. Exemplary embodiments provide a modular, user-friendly adaptor that can be used to upgrade conventional microscopes to a fluorescent microscope and thereby increase the range of applications available to the microscopist. The adaptor can further eliminate the need for complex and expensive traditional fluorescent microscopes and thereby provide opportunities for implementation of fluorescence microscopy in areas of the world without the means or the infrastructure to utilize traditional fluorescent devices.

Exemplary embodiments provide an adaptor that permits easy interchangeability of filter sets by providing a filter arm assembly that can readily be removed from the adaptor and replaced with another without removing the adaptor from the microscope. Exemplary embodiments can further exhibit improved durability, can provide a brighter, more robust light source, and further allow for ready interchanging of objective lenses so that the magnification power can easily and conveniently be adjusted without removing the adaptor from the microscope.

Devices in accordance with the teachings herein provide a more modular and user-friendly design for the microscopist. Moreover, the manufacturing process can be improved by providing components that are more easily and reliably assembled.

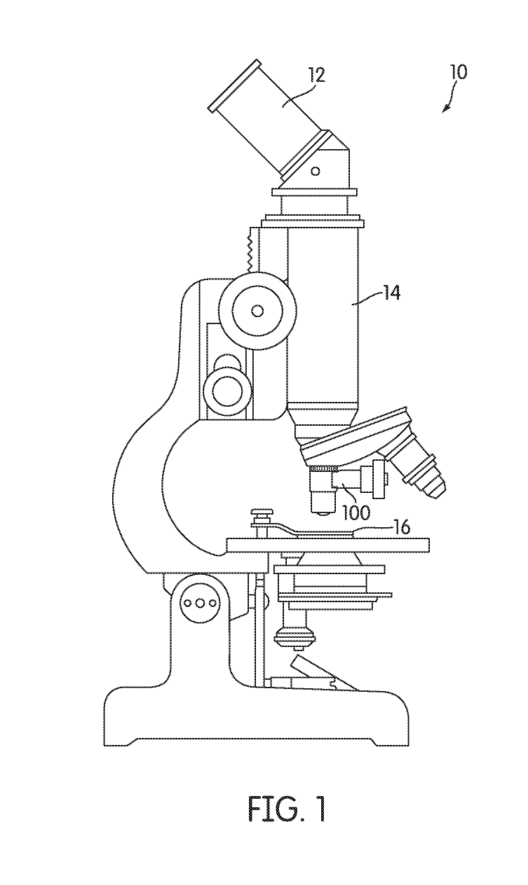

Referring now to FIG. 1, an adaptor 100 in accordance with an exemplary embodiment is shown installed on a conventional microscope 10 having an eye piece 12, a body tube 14, and a specimen holder 16. The adaptor 100 includes a filter arm assembly that may contain all of the filters/reflector (i.e., the entire filter cube) used for a particular operation and a body member that attaches the adaptor 100 to the microscope 10 and which receives the filter arm assembly. The adaptor 100 may also include a microscope objective lens of desired magnification. In some embodiments, the adaptor also includes a light source that attaches to the filter arm and provides incident light to the epi-fluorescent or other fluorescent system. As a result, providing an adaptor 100 in accordance with exemplary embodiments having the desired filter sets and a matching light source allows a user to turn most conventional microscopes into fluorescent microscopes for a particular desired application.

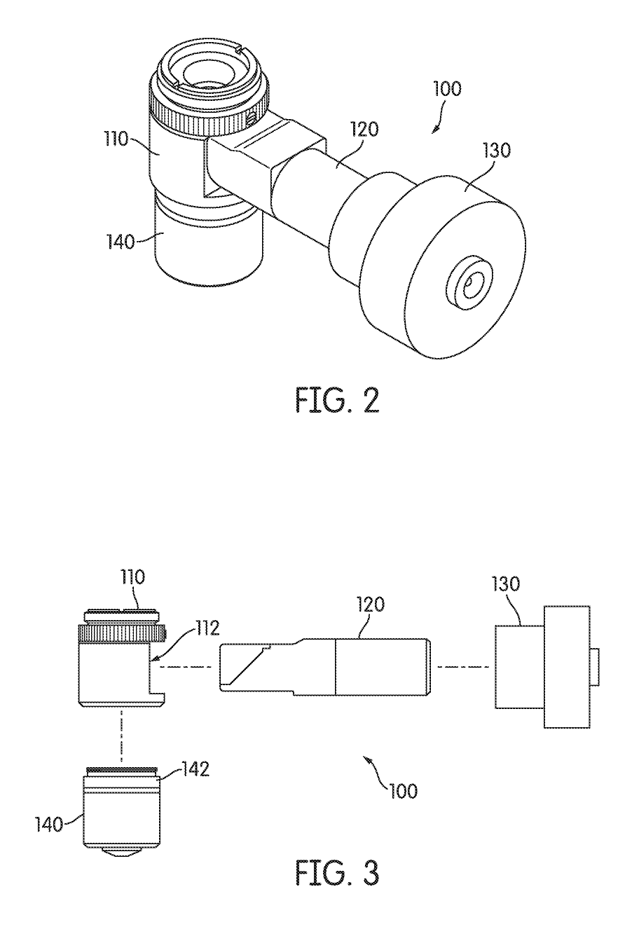

Turning to FIG. 2, the adaptor 100 includes a body member 110 and a filter arm assembly 120 releasably attached to the body member 110, the filter arm assembly 120 being readily interchangeable depending on the filter set needed for a particular application. As also shown in FIG. 2, the adaptor 100 may include a light source 130 attached to the filter arm assembly 120. In some embodiments, the light source 130 and filter arm assembly 120 may be permanently attached.

As seen in FIGS. 2 and 3, the adaptor 100 may also include an objective lens 140 attached to the body member 110. The objective lens 140 may be configured to work in cooperation with the adaptor 100 including, for example, having a quick change feature 142, such as a magnet, that permits multiple different objective lenses of different magnification to be quickly and easily substituted during use.

The filter arm assembly 120 is insertable into the body member 110. Magnets may be used to attach the two assemblies 120, 110 with respect to one another so that they are secured together, but can readily be detached and the filter arm assembly may be removed; any other suitable manner of releasably connecting the two assemblies 120, 110 may also be employed. The body member 110 includes a coupling assembly by which it may be attached to the microscope body tube 14, such as, for example, by threading the adaptor thereto in place of the directly attached objective lens as used in conventional microscopy. The body member 110 may also include a second coupling assembly by which the objective lens 140 may in turn be attached to the adaptor 100 via the body member 110 by, for example, a magnetic attachment, or other suitable attachment mechanism that preferably does not involve rotation of the objective lens as part of the attachment, although the use of threading to attach the objective lens 140 to the body member 110 is also contemplated.

The filter arm assembly 120 is shaped complementary to a filter arm insertion opening 112 of the body member 110 to be received therein. The shape may be of a keyed geometry to ensure proper orientation of the filters contained within the filter arm assembly 120 with respect to the body member 110 for correct microscope operation. Proper filter orientation is obtained when the barrier (emission) filter (as described below) is inserted into the body member 110 such that the barrier filter is at the top of the opening 112.

The filter arm assembly 120 defines a light path therethrough that intersects an axial light path formed in the body member 110 that extends from the body tube 14 of the microscope 10 to the objective lens 140, with the light path through the filter arm assembly 120 being radial with respect to the body member 110. The filter arm assembly 120 may include the light source 130 disposed at one end to emit light along the light path through the filter arm assembly 120 and ultimately through the axial light path of the body member 110 to enable viewing of the specimen via the eye piece 12 by a user of the microscope 10. The light source 130 may be removable from or permanently affixed to the filter arm assembly 120.

The filter arm assembly 120 includes a first filter disposed in the radial (with respect to the body member) light path downstream of the light source 130 for passing light at wavelengths which excite fluorescence in a specimen to be examined using the microscope 10 and for blocking light at wavelengths where visible fluorescence emission occurs in the specimen. The filter arm assembly 120 may include a reflective filter (e.g., a dichroic mirror or beam splitter) disposed at the intersection of the axial light path and radial light path, the reflector also acting as a filter such that excitation wavelengths are reflected toward the specimen through the objective lens while others wavelengths pass through without reflection. An additional filter is disposed in the axial light path between the reflector and the eye piece. The second filter is an emission filter that blocks light at wavelengths shorter than the emission wavelength of the fluorophore used in the specimen and which pass through the reflector.

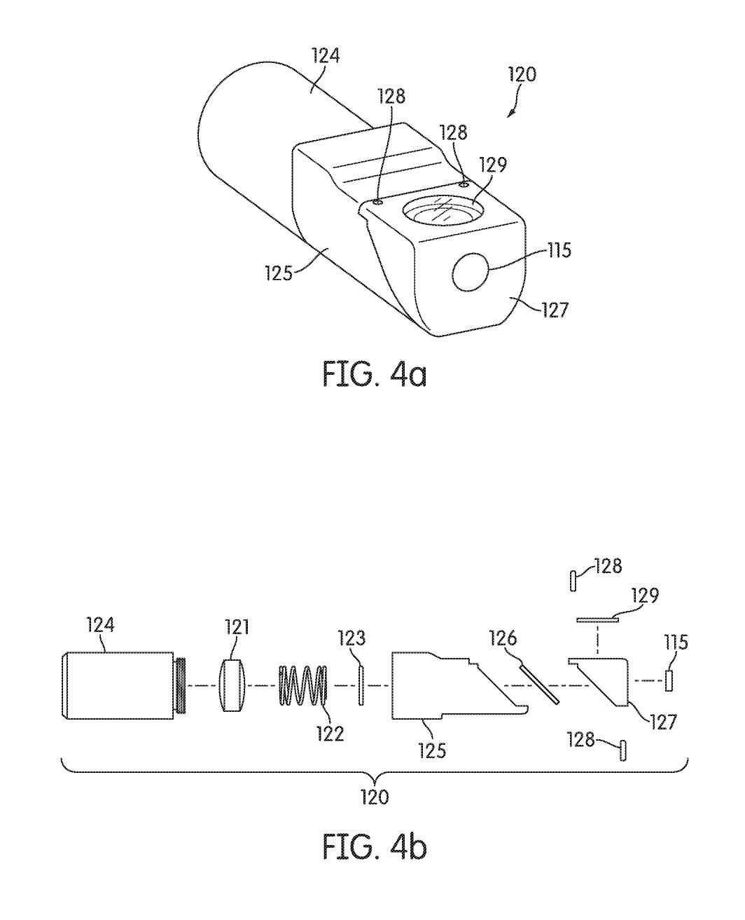

Turning to FIGS. 4a and 4b, the filter arm assembly 120 is shown. The assembly 120 includes an appropriately sized lens 121, spring 122 and the first filter 123, an excitation band pass filter (also sometimes simply referred to as an excitation filter) of a pre-determined specification for a particular application, all of which are disposed between a barrel 124 and a reflector holder 125. The barrel 124 and reflector holder 125 are secured together. This may be accomplished, for example, with an appropriate amount of adhesive or in any other suitable manner. The barrel 124 includes an opening at its distal end that serves as an entrance to the light path passing through the filter assembly 120. The opening can receive, for example, light entering the barrel 124 from a light source 130 mounted on the filter arm assembly 120 (as seen in FIG. 2).

A reflector 126, such as a dichroic mirror, beam splitter or other reflective filter that reflects certain wavelengths of light while allowing others to pass through, of an appropriate pre-determined specification is positioned at an approximately 45 degree angle from horizontal and situated between the reflector holder 125 and a magnet holder 127 that together make up a filter arm housing. The magnet holder 127 is secured to the reflector holder 125 to enclose the reflector 126. The two holders 125, 127 may be secured to one another in any suitable manner; in one embodiment, four spring pins 128 are used. A barrier filter 129 of an appropriate pre-determined specification is attached to the top of the magnet holder 127, for example, by using adhesive. A magnet 115 may be attached to the magnet holder 127, again using any suitable method, including an adhesive. The magnet 115 may be used to retain the filter arm assembly 120 to the body member 110, for example, in conjunction with a corresponding magnet 115 positioned within the body member 110.

As previously noted, the end of the filter arm assembly 120 opposite the barrel 124 can be configured with a one-way geometry or other keying feature to ensure proper orientation of the filter cube components 123, 126, 129 within the assembly 120 when the filter arm assembly 120 is inserted into the body member 110 for attachment to the microscope 100.

For example, the end of the filter arm assembly 120 could be flat on top and rounded on the bottom such that it can only be inserted into the matching shape of the filter arm insertion opening 112 of the body member 110 in one orientation, thereby ensuring proper orientation of the filter set inside the filter assembly 120. In this way, the filters 123, 126, 129 can be consistently and repeatably installed in the correct manner to ensure proper function during use.

An adaptor 100 in accordance with exemplary embodiments may allow the user to remove the filter arm assembly 120 containing a first set of filters and replace it with another filter arm assembly having a different set of filters to accommodate the requirements of a different particular desired application such as, for example, where a sample having a different fluorophore is under examination. That is, different filter arm assemblies 120 may contain a filter cube with a different series of three filters already fixed in the proper alignment and orientation that can be interchanged depending upon a particular predetermined application. In some embodiments, a kit may be provided that comprises a first filter arm assembly having a first set of filters and one or more additional filter arm assemblies, each having a different set of filters. In some embodiments, the kit may further comprise a plurality of different light sources 130 of different wavelengths, each of which may be matched for use with one or more filter assemblies.

Still referring to FIGS. 4a and 4b, in each case, the first filter 123 is an excitation filter 123 (also referred to as a band pass filter) having a pre-determined wavelength cutoff and installed inline with the incident light beam entering the barrel 124. The second filter/reflector 126 may be a dichroic mirror, beam splitter or other reflective filter of a pre-determined wavelength cutoff and mounted at an approximately 45° angle from the incident light beam. Wavelengths of light below this cutoff are reflected through the microscope objective lens 140 to illuminate the sample. Wavelengths of light above the cutoff pass through the reflector 126 without interruption. The third filter 129 is a barrier filter of the desired wavelength, sometimes referred to as an emission band pass filter, installed between the reflector 126 and the user.

The filter arm assembly 120 also contains the focusing lens 121 inline with the incident light beam between the light source and the excitation filter 123. The focusing lens 121 focuses the incident light beam onto the dichroic mirror 126. Additionally, a spring 122 or other retention device may be provided to hold the focusing lens 121 in proper alignment with the light beam.

A benefit of a filter arm assembly 120 in accordance with exemplary embodiments is that all three filter components for a fluorescent microscopy operation (sometimes referred to as a filter cube) are present in a single apparatus and these filters are installed a permanent way that ensures the proper alignment of the filters and the light path in a consistent and repeatable manner. As long as the proper excitation bandpass, dichroic mirror and emission band pass filters are selected for a predetermined application of interest and the filters are installed properly, an infinite number of filter combinations can be produced to match any desired application.

Yet another benefit of an adaptor in accordance with exemplary embodiments is that the light shaft can be extended to any desired length within the focusing limits of the lenses used. Accordingly, fluorescent microscope adaptors 100 in accordance with exemplary embodiments may be used in situations where conventional adaptors have been unusable because of size and/or space constraints. Extension of the light shaft could allow the device to be modified to be used in these situations. For example, the user can add a fiber-optic cable of desired length extending between the LED light source and the filter arm assembly and, if necessary, change the lens set in the LED light source to maintain proper focus and intensity of the desired wavelength of light. This can add greater flexibility and allow use of the adaptor on space constrained microscopes, such as with inverted microscopes. This further allows the fluorescent microscope adaptor 100 to be used for almost any desired application.

Additionally, to ensure proper orientation, the teachings also provide a means for the complete insertion of the filter arm into the body member. This may be accomplished by the use of a magnet installed on the end of the filter arm distal from the light input opening and a complementary magnet installed inside the body member inline with the filter arm insertion shaft. When installed properly, the magnets will attract and ensure complete installation and alignment of the filters and the light path.

Another benefit of exemplary embodiments is that adhesive use can be reduced, including, for example, by connecting the portions 125/127 of the filter arm assembly 120 that house the reflector 126 with a series of pins 128. The use of adhesive can make proper alignment of the reflector difficult. Furthermore, adhesive residue can affect the quality and the operation of the apparatus. By using pins 128 to secure portions of the filter arm assembly 120, proper alignment becomes easier, installation cleaner, and provides a more efficient manufacturing process.

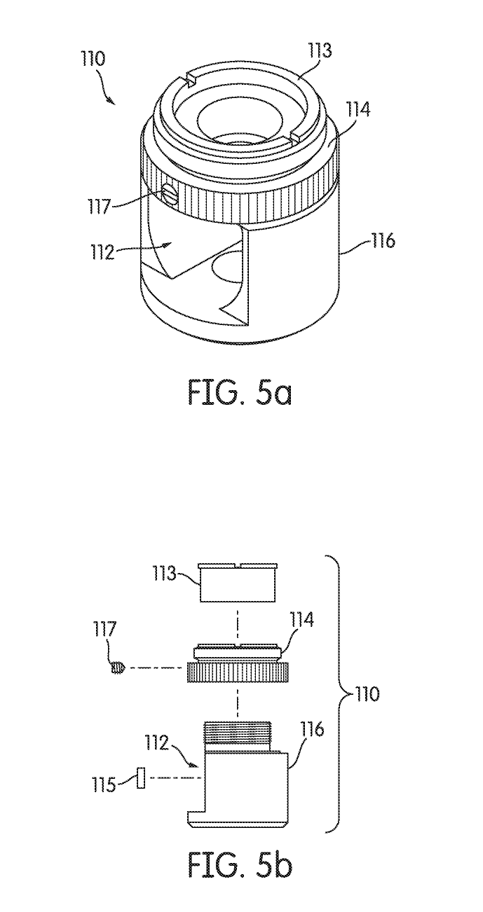

FIGS. 5a and 5b depict the body member 110. The body member 110 has an axial light path running longitudinally therethrough and includes the filter arm assembly opening 112 formed in a radial direction relative to the longitudinal dimension of the body member to receive the filter arm assembly 120.

The body member 110 includes a coupling assembly for coupling the body member 110 (and thus the adaptor 100) to the microscope 10. The coupling assembly may include an optional retainer ring 113 and a microscope threading ring 114 with appropriate threading to connect the main barrel 116 of the body member 110 to the microscope 10. The threading ring 114 may be attached to the main barrel 116 in any suitable manner, including the use of an adhesive and/or a set screw 117. A magnet 115 may be attached to the inside of the main barrel 116 of the body member 110, the magnet 115 positioned to be attracted to a corresponding magnet 115 in the filter arm assembly 120 and thereby retain the filter arm assembly 120 at its proper location within the body member 110. As previously described, the body member 110 includes a filter arm insertion opening 112 configured to receive the filter arm assembly 120.

The body member 110 includes a coupling assembly on the underside of the main barrel 116 for attachment of the objective lens 140. This may include the use of threading to attach the objective lens 140 to the body member 110. Alternatively, the main barrel 116 may be metallic and/or have a magnet disposed on its underside to attach to the objective lens 140. In addition, the body member 110 and/or the objective lens 140 may comprise a magnetic material. As a result, the objective lens 140 can be attached or removed from the body member 110 without the need for threading, avoiding rotation of the objective lens 140. Furthermore, the use of a magnetic attachment for the objective lens 140 to the body member 110 allows for a more user-friendly assembly process and also allows for easily switching between objective lenses of two or more different magnifications, a technique routinely used by microscopists.

According to yet another embodiment, a light source 130 is provided as part of the adaptor 100 that can be permanently or removably attached to the filter arm assembly 120. In one embodiment, the light source 130 is an LED source containing an LED bulb. The use of an LED provides a brighter, more robust light source. Advantageously, because the driver board, rheostat and power source that control bulb operation can be used for multiple different light sources, these components can be omitted from the light source 130 and be separately connected to the light source 130. As a result of omitting these components, the light source 130 can be made smaller and more convenient to the user for direct attachment to the adaptor 100, while still permitting the filter arm assembly 120 and/or light source 130 to be interchanged for different applications. In embodiments in which the light source 130 is removably attached to the filter arm assembly 120, light sources having LEDs of different wavelengths can also be readily interchanged with respect to a single filter arm assembly 120 depending upon the application.

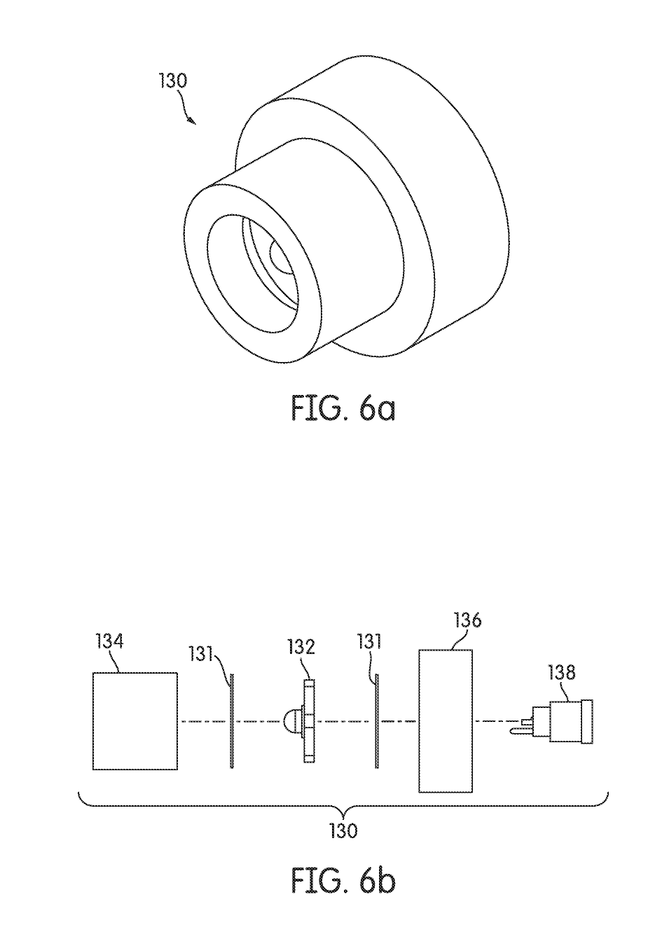

As shown in FIGS. 6a and 6b, the light source 130 includes one or more LED bulbs 132 of appropriate output situate between two retainer rings 131, all contained within LED housing 134. The LED housing 134 is attached to an electrical connection housing 136, to which an appropriate electrical connection 138 is attached. The electrical connection 138 is in electrical communication with the LED bulb(s) 132 and can further be connected by a cable, for example, to the driver board, rheostat and power source (not shown) to operate the bulb 132 in a desired manner.

It will be appreciated that various parts of the adaptor may be made of plastic, metal or other suitable materials. Furthermore, where parts are described as optionally being assembled using an adhesive, commercially available adhesive agents, such as those available under the trademark LOCTITE, may be used, for example, to secure certain filters into the proper position.

The section headings used herein are for organizational purposes only and are not to be construed as limiting the subject matter described in any way.

It will be apparent to those skilled in the art that various modifications and variations can be made to the adaptor for microscopes of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. An adaptor for converting a conventional, non-fluorescent light microscope into a fluorescent microscope, the adaptor comprising:
a body member configured at one end thereof to attach to a body tube of the microscope and configured at an opposite end thereof to attach to a microscope objective lens, the body tube further having an opening formed in a side thereof;
a filter arm assembly insertable into the opening of the body member such that the filter arm assembly is removably attached to the body member, the filter arm assembly having a light path therethrough that intersects an axial light path through the body member extending from the body tube to the objective lens, the filter arm assembly further comprising a filter cube for fluorescent microscopy disposed therein.

2. The adaptor of claim 1, wherein the filter arm assembly is keyed to be insertable into the body member in a single orientation.

3. The adaptor of claim 1, wherein the filter arm assembly is magnetically attachable to the body member.

4. The adaptor of claim 1, wherein the filter cube comprises an excitation band pass filter, a dichroic mirror, and a barrier filter associated with a predetermined wavelength.

5. The adaptor of claim 4, further comprising a focusing lens and spring disposed within the filter arm assembly.

6. The adaptor of claim 4, wherein spring pins secure the dichroic mirror within the filter arm assembly.

7. The adaptor of claim 1, wherein the objective lens is detachably coupled to the body member.

8. The adaptor of claim 7, wherein the objective lens is magnetically attached to the body member.

9. The adaptor of claim 1, further comprising a light source attached to the filter arm assembly.

10. The adaptor of claim 9, wherein the light source comprises an LED.

11. The adaptor of claim 10, wherein the light source further comprises an electrical connection for electrically connecting the light source to a driver board, rheostat and power source.

12. The adaptor of claim 9, wherein the light source is removably attached to the filter arm assembly.

13. An adaptor for converting a conventional, non-fluorescent light microscope into a fluorescent microscope, the adaptor comprising:
a body member configured at one end thereof for detachably coupling directly to a body tube of the microscope and configured at another end thereof for magnetically coupling to a microscope objective lens, the body member having an axial light path running longitudinally therethrough, the body member including an opening in a radial direction relative to the longitudinal dimension of the body member;
a filter arm assembly slidably insertable into the opening of the body member in a single orientation such that the filter arm assembly has a radial light path which intersects the axial light path, the filter arm assembly being magnetically attached to the body member;
a light source removably attached to an end of the filter arm assembly opposite the body member, the light source comprising an LED and disposed to emit light from the LED along the radial light path;
the filter arm assembly further comprising
a first filter disposed in the radial light path downstream of the light source for passing light at wavelengths which excite fluorescence in a specimen to be examined in the microscope and for blocking light at wavelengths where visible fluorescence emission occurs in the specimen;
a reflector disposed at the intersection of the axial light path and radial light path, the reflector passing light through the axial light path and reflecting light at excitation wavelengths; and
a second filter disposed in the axial light path and disposed between the reflector and the eye piece, the second filter blocking light at wavelengths shorter than the emission wavelength of a predetermined fluorophore used in a sample under examination and which wavelengths pass through the reflector.

14. An adaptor kit for converting a conventional, non-fluorescent light microscope into a fluorescent microscope, the kit comprising:
a first filter arm assembly removably insertable into a side opening of a body member configured to attach to a body tube of the microscope and configured at an opposite end thereof to attach to a microscope objective lens, the first filter arm assembly having a light path therethrough that intersects an axial light path through the body member extending from the body tube to the objective lens, the filter arm assembly further comprising a first filter cube for fluorescent microscopy disposed therein associated with a first predetermined wavelength; and
a second filter arm assembly removably insertable into the side opening of the body member, the second filter arm assembly having a light path therethrough that intersects the axial light path through the body member, the second filter arm assembly further comprising a second filter cube for fluorescent microscopy disposed therein associated with a second predetermined wavelength.

15. A method of adapting a conventional, non-fluorescent microscope into a fluorescent microscope, said conventional microscope comprising a vertical body tube, an eye piece disposed at one end of said body tube, an objective lens disposed at another end of said body tube, and a means for retaining a specimen plate under said objective lens, the method comprising the steps of:
providing the adaptor of claim 1;
attaching the body member to the objective lens; and
attaching the body member to the body tube of the microscope.
